(19) United States
(12) Patent Application Publication
(10) Pub. No.: US 2005/0007974 A1
(43) Pub. Date: Jan. 13, 2005

(54) Method for identifying walsh code space

(76) Inventors: Subramanian Vasudevan, Morristown, NJ (US); Yunsong Yang, Piscataway, NJ (US)

Correspondence Address: Docket Administrator (Room 3J-219);Lucent Technologies Inc., 101 Crawfords Corner Road, Holmdel, NJ, 07733-3030, US

(21) Appl. No.: 10/386,173

(22) Filed: Jul. 7, 2003

(51) Int. Cl. H04J 11/00

(52) U.S. Cl. 370/320; 370/335; 370/342; 370/441; 370/209

(57) ABSTRACT

A method of identifying the available Walsh code space. The method includes at least one wireless unit receiving a Walsh code-based signal. The Walsh code-based signal may be transmitted by a base station, for example. The Walsh code-based signal may be realized by 13 bits, for example, corresponding to indices in a look-up table within the mobile unit that should not be employed. Thereafter, the wireless unit may determine the remaining Walsh code space. This determination step may include ascertaining which indices in the look-up table are relevant, and thusly, removing irrelevant indices. Subsequently, the step of determining the remaining Walsh code space may include examining the Walsh Table ID signal received from the base station to identify the remaining Walsh codes space.

### BACKGROUND OF THE INVENTION

I. Field of the Invention

The present invention relates to communication systems, and more particularly, to spreading or Walsh codes.

II. Description of the Related Art

Wireless communications systems provide wireless service to a number of wireless or mobile units situated within a geographic region. The geographic region supported by a wireless communications system is divided into spatially distinct areas commonly referred to as “cells.” Each cell, ideally, may be represented by a hexagon in a honeycomb pattern. In practice, however, each cell may have an irregular shape, depending on various factors including the topography of the terrain surrounding the cell. Moreover, each cell is further broken into two or more sectors. Each cell is commonly divided into three sectors, each having a range of 120 degrees.

A conventional cellular system comprises a number of cell sites or base stations geographically distributed to support the transmission and reception of communication signals to and from the wireless or mobile units. Each cell site handles voice communications within a cell. Moreover, the overall coverage area for the cellular system may be defined by the union of cells for all of the cell sites, where the coverage areas for nearby cell sites overlap to ensure, where possible, contiguous communication coverage within the outer boundaries of the system's coverage area.

Each base station comprises at least one radio and at least one antenna for communicating with the wireless units in that cell. Moreover, each base station also comprises transmission equipment for communicating with a Mobile Switching Center (“MSC”). A mobile switching center is responsible for, among other things, establishing and maintaining calls between the wireless units, between a wireless unit and a wireline unit through a public switched telephone network (“PSTN”), as well as between a wireless unit and a packet data network (“PDN”), such as the Internet. A base station controller (“BSC”) administers the radio resources for one or more base stations and relays this information to the MSC.

When active, a wireless unit receives signals from at least one base station or cell site over a forward link or downlink and transmits signals to at least one cell site or base station over a reverse link or uplink. There are many different schemes for defining wireless links or channels for a cellular communication system. These schemes include, for example, TDMA (“time-division multiple access”), FDMA (“frequency-division multiple access”), and CDMA (“code-division multiple access”) schemes.

In a CDMA scheme, each wireless channel is distinguished by a distinct channelization code (e.g., spreading code, spread spectrum code or Walsh code) that is used to encode different information streams. These information streams may then be modulated at one or more different carrier frequencies for simultaneous transmission. A receiver may recover a particular stream from a received signal using the appropriate Walsh code to decode the received signal.

Each base station using a spread spectrum scheme, such as CDMA, offers a number of Walsh codes, and consequently, a corresponding number of users, within each sector of a cell. In the CDMA 2000 3G-1×, for example, the number of Walsh codes made available by each sector may be defined by the radio configuration (“RC”) employed by the base station. Consequently, the maximum number of Walsh codes available for an RC3 assignment is 64, for example, while an RC4 assignment, in contrast, supports a maximum of 128 Walsh codes. Under certain conditions, such as when the majority of users are in benign RF environment, the users are concentrated in the area near antenna or majority of the users are stationary, etc., the capacity of CDMA 2000 3G-1× may exceed the Walsh code capability of an RC3 assignment. RC3 limitation is also expected to be exceeded when technologies, such as transmit diversity, an intelligent antenna(s), and/or a selectable mode vocoder(s) are introduced.

The number of Walsh codes made available by the base station takes into consideration the transmit power requirements associated with the selected radio configuration. For example, an RC4 assignment requires a relatively longer spreading code and has a greater transmit power requirement than an RC3 assignment, which is a relatively shorter spreading code. Consequently, a tradeoff exists between the power efficiency of the base station based on the RC configuration employed and the length/number of spreading codes made available within each sector of a cell. For example, an RC4 assignment may degrade capacity by supporting a weaker coding rate than an RC3 assignment.

As noted hereinabove, the number of available Walsh codes is fixed by the RC of the base station. In CDMA 2000 1×EV-DV, a base station may be designated with an RC10 assignment, and voice and circuit data calls may be given priority over other traffic, such as data packet calls, in the allocation of Walsh codes. More particularly, on the forward link, the base station may designate available Walsh codes to voice and circuit data calls first, before assigning any remaining codes from the Walsh code space to other traffic (e.g., data packet calls). As the number of Walsh codes may remain static for periods of time, the allocation between voice/circuit data and other traffic (e.g., data packet calls) may change dynamically with changes in the voice/circuit data traffic.

Given the dynamic fluctuations in voice/circuit data traffic, a need exists for a method to identify the remaining available (e.g., unused or unassigned) Walsh codes. A demand exists for such a method so that a wireless unit initiating a new data packet call, for example, may ascertain one or more available Walsh codes for use.

### SUMMARY OF THE INVENTION

The present invention provides a method of identifying the remaining available unassigned Walsh codes. More particularly, the present invention offers a method of identifying the remaining availability of the Walsh code space for at least one wireless unit by receiving a Walsh code-based signal. The Walsh code-based signal may be transmitted by a base station, for example. The Walsh code-based signal, once received by the wireless unit, may determine the remaining Walsh codes available, if any, by utilizing a look-up table.

In accordance with one embodiment of the present invention, the Walsh code-based signal may comprise an information field having a number (e.g., 13) of bits. Each of the number of bits corresponds with at least one of the indices in a look-up table within the wireless unit. Here, bit is mapped from the Walsh code-based signal to two indices, for example, in the look-up table. The binary value of each bit determines if the corresponding index should or should not be removed. Thereafter, the mobile unit may determine the remaining available unassigned Walsh codes. This determination step may include transmitting by the base station and receiving by the wireless unit a Walsh Table ID signal. The Walsh Table ID signal corresponds with a column on the look-up table and a maximum number of paging channels used by the base station on the same carrier frequency, for example, as the data channel (e.g., shared packet data channel). Subsequently, the step of determining the remaining Walsh code space may include identifying the unassigned Walsh codes in response to the remaining indices not removed and the Walsh Table ID signal.

In accordance with another embodiment of the present invention, a data call may be placed using at least one unassigned Walsh code that has been identified. The method here includes the step of examining a Last Walsh Code Index for each identified unassigned Walsh code if at least two data channels are available. Thereafter, each identified unassigned Walsh code is categorized if the corresponding index in the look-up table is within a first or a second range. The first range may be defined between zero and a first integer number, N, while the second range may be defined between N+1 and a second integer number, M, where the second integer number, M, may be a variable number. The second integer number, M, may also correspond with available resources. The number, N, may be designated as the Last Walsh Code Index 0, and the number, M, may be designated as the Last Walsh Code Index 1. This terminology indicates the upper bounds of the look-up indices available for the shared packet data channel 0 and the shared packet data channel 1.

In accordance with yet another embodiment of the present invention, the base station examines the number of channels (e.g., paging channels) in use prior to transmitting the Walsh Table ID signal. The Walsh Table ID signal corresponds with a column on the look-up table and a maximum number of paging channels used by the base station on the same carrier frequency, for example, as the data channel (e.g., shared packet data channel). These channels may exclusively comprise paging channels, or alternatively, one or more paging channels, for example. Once the number of channels has been examined, the Walsh Table ID signal may be configured. Here, the Walsh Table ID is designed to be greater than or equal to the number of paging channels in use.

These and other embodiments will become apparent to those skilled in the art from the following detailed description read in conjunction with the appended claims and the drawings attached hereto.

### BRIEF DESCRIPTION OF THE DRAWINGS

The present invention will be better understood from reading the following description of non-limiting embodiments, with reference to the attached drawings, wherein below:

FIG. 1 depicts a flow chart of an embodiment of the present invention;

FIG. 2 depicts an aspect of the present invention;

FIG. 3(a) depict another aspect of the present invention, while FIG. 3(b) depicts an alternative perspective of FIG. 3(a); and

FIGS. 4 through 11 depict additional aspects of the present invention.

It should be emphasized that the drawings of the instant application are not to scale but are merely schematic representations, and thus are not intended to portray the specific dimensions of the invention, which may be determined by skilled artisans through examination of the disclosure herein.

### DETAILED DESCRIPTION

Revision C of the IS-2000 standard, also known as 1×-EVDV (1× evolution for data and voice), specifies a code-division multiple access (“CDMA”) system that allows voice and packet-data services to be offered concurrently, on a single radio frequency carrier. On the downlink, i.e. from the base station to the wireless unit, the frequency spectrum associated with such a carrier is separated into a number of physical channels by means of distinct channelization codes (e.g., spreading code, spread spectrum code or Walsh code). Each voice user on the system is assigned a Walsh code that carries the voice traffic destined for the user. Additional Walsh codes may be assigned to dedicated data channels carrying circuit-switched data to users. The Walsh codes that remain after assignment to voice and circuit-switched data users are consolidated into a shared packet data channel, to carry packet-data traffic to other users on the system. The Walsh codes used by the shared packet data channel, however, may vary over time depending on the number of voice and circuit-switched data users active in the system.

In order for a packet-data user to receive information being transmitted thereto on the shared packet data channel, the user should be notified of the Walsh codes being utilized by the packet data channel at the time of data transmission to him. However, as noted hereinabove, the Walsh codes used by the shared packet data channel, however, may vary over time depending on the number of voice and circuit-switched data users active in the system. Consequently, a method is required of identifying the Walsh codes in use at that time.

The present invention provides a method of identifying the remaining available unassigned Walsh codes. More particularly, the present invention offers a method of identifying the remaining availability of the Walsh code space for at least one wireless unit by receiving a Walsh code-based signal. The Walsh code-based signal may be transmitted by a base station, for example. The Walsh code-based signal, once received by the wireless unit, may determine the remaining Walsh codes available, if any, by utilizing a look-up table.

In a first embodiment, a signal is transmitted by a base station and received by each relevant user of the set of Walsh codes (or Walsh Space) in use. This signal may be transmitted via the special use of a downlink control channel normally accompanying transmissions on the shared packet data channel, identifying their format and the intended recipients. The special use consists of reserving and designating a particular value (e.g., all zeros) of the user-identity field in the control channel message, as an indication that Walsh space information is being carried on the particular transmission. The remaining information fields in this case may map out the Walsh codes to be employed subsequently by users receiving traffic on the shared packet data channel.

Alternatively, the Walsh codes being used by a shared channel, such as the wireless packet data channel in CDMA 2000 Rev. C network, for example, from the Walsh code-based signal. This Walsh code-based signal may also be referred to as a Walsh Mask indication. The Walsh code-based signal or Walsh Mask indication may be received on the downlink packet data control channel, for example, by each relevant wireless unit.

In accordance with one embodiment of the present invention, the Walsh code-based signal may comprise an information field having a number (e.g., 13) of bits. Each of the number of bits corresponds with at least one of the indices in a look-up table within the wireless unit. Here, bit is mapped from the Walsh code-based signal to two indices, for example, in the look-up table. The binary value of each bit determines if the corresponding index should or should not be removed. Thereafter, the mobile unit may determine the remaining available unassigned Walsh codes. This determination step may include transmitting by the base station and receiving by the wireless unit a Walsh Table ID signal. The Walsh Table ID signal corresponds with a column on the look-up table and a maximum number of paging channels used by the base station on the same carrier frequency, for example, as the data channel (e.g., shared packet data channel). This step of determining the remaining Walsh code space may include identifying the unassigned Walsh codes in response to the remaining indices not removed and the Walsh Table ID signal. The Walsh Table ID signal may identify an appropriate pointer(s) to the look-up table. With the pointer and the unremoved indices, the remaining unassigned Walsh codes may be ascertained.

In accordance with another embodiment of the present invention, a data call may be placed using at least one unassigned Walsh code that has been identified. The method here includes the step of examining a Last Walsh Code Index for each identified unassigned Walsh code if at least two data channels are available. Thereafter, each identified unassigned Walsh code is categorized if the corresponding index in the look-up table is within first or a second range. The first range may be defined between zero and a first integer number, N, while the second range may be defined between N+1 and a second integer number, M, where the second integer number, M, may be a variable number. The second integer number, M, may also correspond with available resources. The second integer number, M, may also correspond with available resources. The number, N, may be designated as the Last Walsh Code Index 0, and the number, M, may be designated as the Last Walsh Code Index 1. This terminology indicates the upper bounds of the look-up indices available for the shared packet data channel 0 and the shared packet data channel 1.

In accordance with yet another embodiment of the present invention, the base station examines the number of channels (e.g., paging channels) in use prior to transmitting the Walsh Table ID signal. The Walsh Table ID signal corresponds with a column on the look-up table and a maximum number of paging channels used by the base station on the same carrier frequency, for example, as the data channel (e.g., shared packet data channel). These channels may exclusively comprise paging channels, or alternatively, one or more paging channels, for example. Once the number of channels has been examined, the Walsh Table ID signal may be configured. Here, the Walsh Table ID is designed to be greater than or equal to the number of paging channels in use.

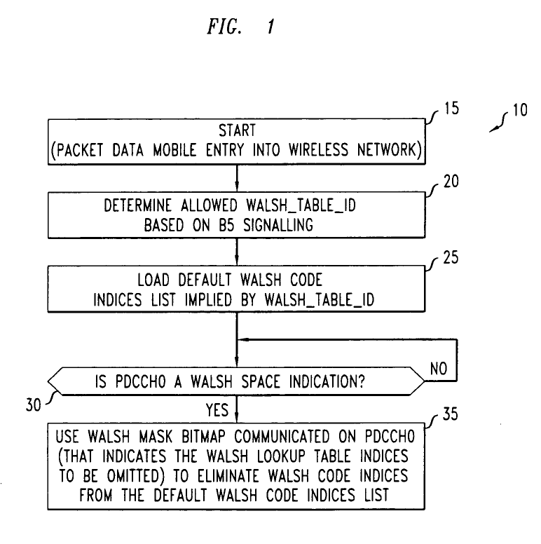

Referring to FIG. 1, a flow chart 10 of one embodiment of the present invention is shown. The first step of the method includes initiating and initializing the wireless or mobile unit into the wireless network (15). The wireless unit, here, may seek data services. In one example, the wireless unit is seeking packet data services.

Thereafter, a Walsh Table ID signal is transmitted by the base station. Prior thereto, however, the base station examines its resources. The examination step may include determining the number of channels (e.g., paging channels) in use. Subsequently, the base station configures the Walsh Table ID signal based on the number of paging channels (20). The Walsh Table ID signal may be configured to be greater than the number of paging channels. It should be noted that the Walsh Table ID signal may correspond with a column on a look-up table in the wireless unit, as well as with a maximum number of paging channels supported by a base station.

A Walsh code-base signal is also transmitted by the base station and received by the wireless unit. This code-base signal comprises an information field having a number of bits. Each information bit corresponds with at least one of a number of indices the look-up table. The indices, moreover, may correspond with one or more unassigned Walsh codes. Consequently, each bit from the Walsh code-based signal may be mapped to at least one of the indices in the look-up table.

Once the Walsh Table ID signal is transmitted by the base station and received by the wireless unit, the default Walsh code indices, as stored in the look-up table within the wireless unit are loaded (25). Here, the process of determining at least one unassigned Walsh code may be initiated (30).

The wireless unit receiver monitors two downlink control channels associated with the shared packet data channel. These may be designated Packet Data Control Channel Zero (PDCCH0) and Packet Data Control Channel One (PDCCH1) , for example. Each Packet Data Control Channel, for example, may be associated with a shared Packet Data Channel. In one embodiment, the Walsh space indication is sent on PDCCH0. This information may be carried on a multi-bit (e.g., 13 bit) information field and denoted as the Walsh Mask bitmap.

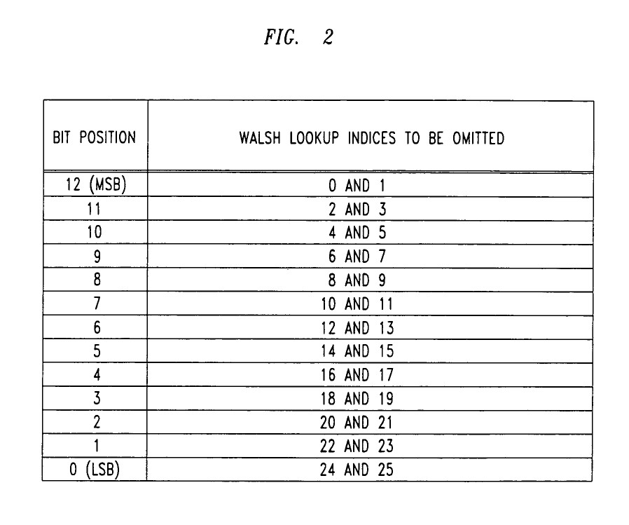

The mobile may identify the message on PDCCH0 as a Walsh space indication if the user identity field consists of all zeros. Upon receiving the Walsh Mask bitmap on PDCCH0, for example, the wireless unit may use the exemplary table shown in FIG. 2 to determine the Walsh code indices to be omitted from the list of Walsh codes. FIG. 2 may be described as showing the mapping between the PDCCH0 bit positions and the Walsh lookup indices, or the . The indexing of Walsh codes from 1 to 32 may be known to both base station and wireless unit.

In one embodiment, the wireless unit may determine that it is the intended recipient of a data transmission if its user identity is indicated in either the control channel (PDCCH0 or PDCCH1) fields. The same control message may also indicate one end of Walsh code list to be used by associated shared packet data channel (PDCH0 or PDCH1). This index of the list may be denoted Last Walsh Space Index (“LWSI”) and runs from 0 to 31.

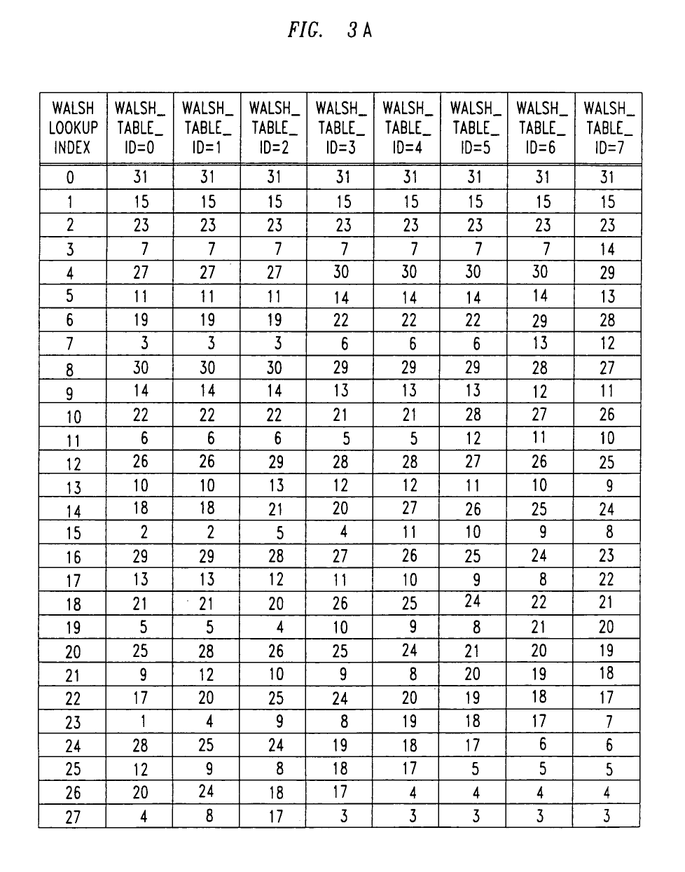

In yet another embodiment, the wireless unit may use knowledge of LWSI and Walsh Mask bitmap to form the vector of lookup indices. In so doing, the row entries to the Walsh Code Indices (“WCI”) table may be selected. Thereafter, the Walsh Table ID signal may be used as the column index in the WCI table to fetch the vector of the actual Walsh codes indices as shown hereinbelow:
For PDCH0:
   wci_set=WCI((0 . . . lwsi0)−WALSH_MASK, WALSH_TABLE_ID) Equation I
For PDCH1:
   wci_set=WCI((lwsi0+1 . . . lwsi1)−WALSH_MASK, WALSH_TABLE_ID) Equation II
   wherein Walsh Mask means removing those indices of which the omission has been indicated in the Walsh Mask according to the mapping relationship exemplary shown in FIG. 3(a). FIG. 3(a) may be characterized as depicting the Walsh Code Indices (“WCI”) table. With respect to FIG. 3(a), it should be noted that if the number of paging channels is greater than a particular Walsh Table ID, this Walsh Table ID may not be used. In order to form the primitive wci_set in PHY-FPDCH Request and PHY-Decode FPDCH Request, two inputs may be needed as the parameters in order to use the WCI lookup table. If we consider WCI table as a matrix, then one parameter is a vector of row indices. The other parameter is a single value of column index.

As noted hereinabove, the PDCHCF may use the knowledge of LWSI and Walsh Mask bitmap to form the vector of lookup indices to select the row entries to the WCI table. Thereafter, the Walsh Table ID signal may be used as the column index in the WCI table to fetch the vector of the actual Walsh codes indices. This methodology is reflected in equations I and II shown hereinabove.

The mapping between the Walsh indices with the actual Walsh codes may be of significance for the operation of the F-PDCH. This is in part due to the wireless unit not only requiring the exact Walsh codes to be used, but also the right order to be used in order to reconstruct the EP. Therefore, it may be important to have the default Walsh table in the baseline text for completeness.

The modulated symbols shall be demultiplexed into those Walsh subchannels indicated in wci_set in the PHY-FPDCH REQUEST and PHY-Decode FPDCH REQUEST, and in the order they are indicated in wci_set. Each Walsh channel shall be Walsh spread, and the spread symbols from the Walsh channels shall be summed as specified in 3.1.3.15.11.

With respect to forward packet data channel transmission processing, when the Physical Layer receives a PHY-FPDCH Request (ep, spid, num_slots, wci_set, sys_time) primitive from the MAC Layer, the base station may perform the following steps:
(1) Set the SDU=ep;
(2) Store the arguments spid, num_slots, wci_set, and sys_time; and
(3) Transmit the SDU on the Forward Packet Data Channel with frame of duration num_slots, over those Walsh subchannels indicated in wci_set and in the order they are indicated in wci_set, at the sys_time.

Referring to FIG. 3(b), a table is shown. The table of FIG. 3(b) incorporates the elements of mapping relationship exemplary shown in FIG. 3(a) up until Walsh lookup index 23, though not specifically depicted. Walsh lookup index 22 is included for the purposes of visual assistance. From Walsh lookup index 23, the distinctions between the table of FIG. 3(a) and the table of FIG. 3(b) may be viewed. Here, the last column is filled for the case of seven PCHs, instead of reserved for customized the Walsh table. The overhead channel Walsh assignment, while merely for illustration, may be realized differently in actual implementation.

The PDCHCF will use the knowledge of LWSI and Walsh Mask to find the range of indices in the look up table. Thereafter, the Walsh Table may be used for corresponding to the number of PCHs in order to find the exact Walsh code indices. This allows for the formation of the primitive wci_set in PHY-FPDCH Request and PHY-Decode FPDCH Request.

Regarding to the order of Walsh codes to be used to demux the SDU and later to reconstruct the SDU, it can be either the order of which the Walsh codes appears in wci_set or the natural order (i.e. the numerical subscript number) of the Walsh codes in wci_set be used at the transmitter and receiver. In any case, the baseline should specify one methodology.

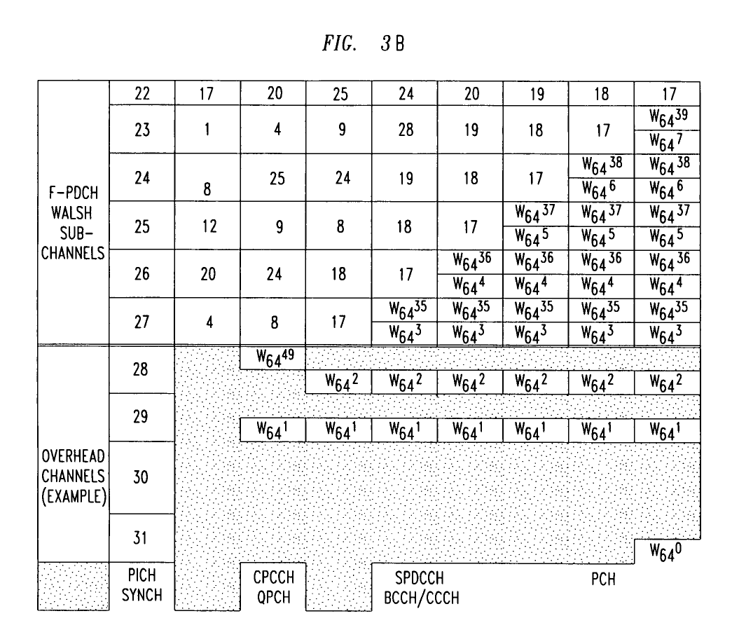

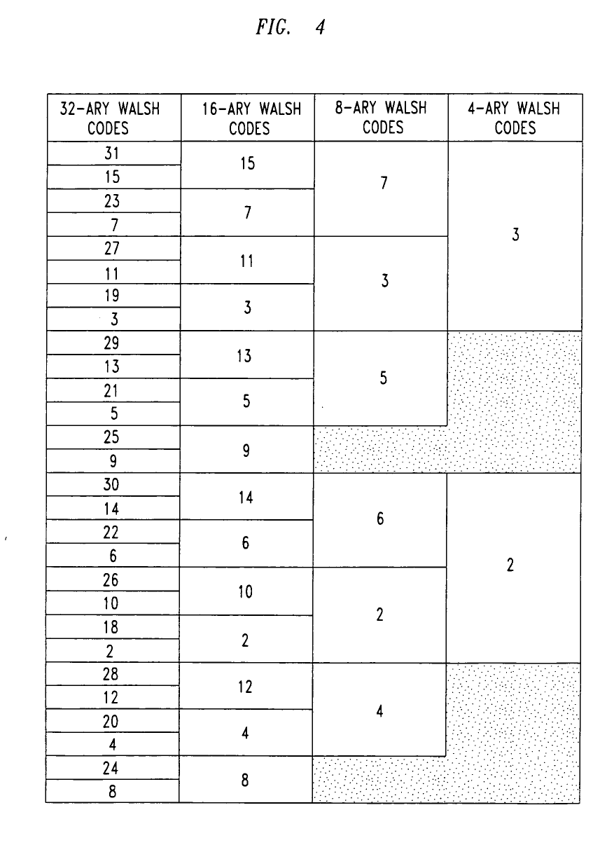

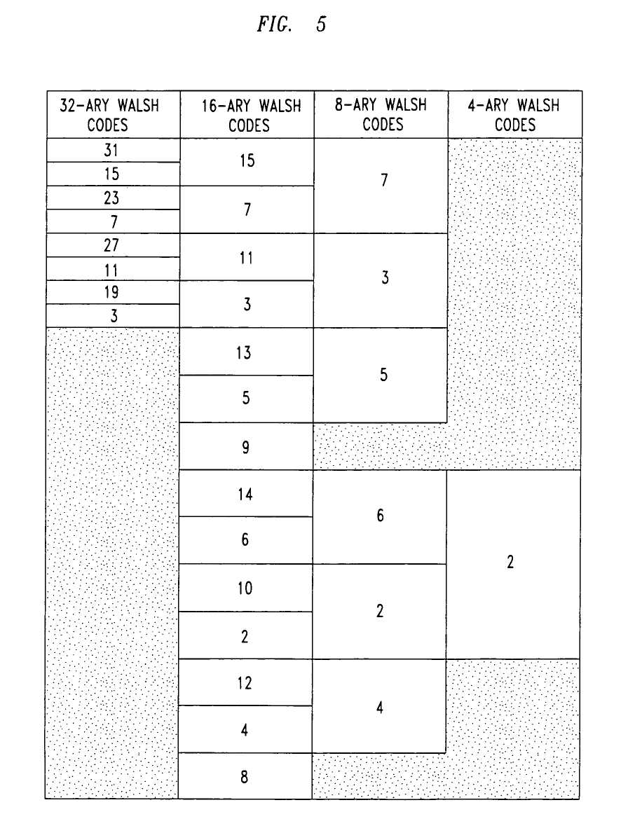

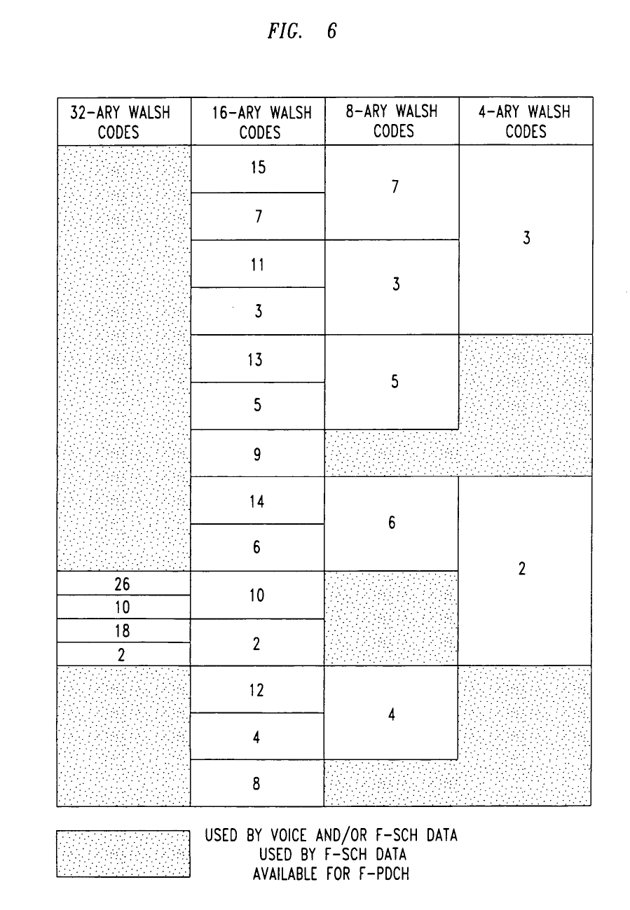

It should be noted that a need exists for a Walsh Space Broadcast capability in the 1x-EVDV system and present system simulation results for Walsh space broadcast on the FSPDCCH. The need for a Walsh space broadcast stems especially from use of the CDMA 2000 F-SCH in an EVDV system. The current mode of operation of the F-PDCH assumes that: (i) the top end of the ordered list of 32-ary Walsh codes, as depicted in FIG. 4, may be ascertainable, and (ii) the available Walsh space is contiguous. As shown in FIG. 5 and FIG. 6, either condition may be violated if the legacy 1× data mobile uses F-SCH with a Walsh code larger than 32-ary. As a result, some portion of the Walsh space available for the F-PDCH is either unusable or used inefficiently.

In an embodiment of the present invention, use the F-SPDCCH to indicate available Walsh space for the F-PDCH, via a bit-map, when the F-SCH(s) operation may cause invalid default starting code (i.e. other thanW3132) or fragmented Walsh space. A special MACID will indicate the current SPDCCH carries Walsh Space Bitmap. This is depicted in FIG. 7.

The reason for a 16-ary bitmap may be that F-SCH assignments that create holes or invalid default starting code in the available Walsh space for the F-PDCH will be using 16-ary or larger Walsh codes, i.e. if F-SCH only requires 32-ary or smaller Walsh code, it will be assigned from the bottom of the Walsh space list, not causing any problems. And W816is not explicitly indicated in the bitmap because its availability (or unavailability) may not cause either of the problems mentioned before. Thus this signaling capability will solve the Walsh space problems associated with the use of F-SCH.

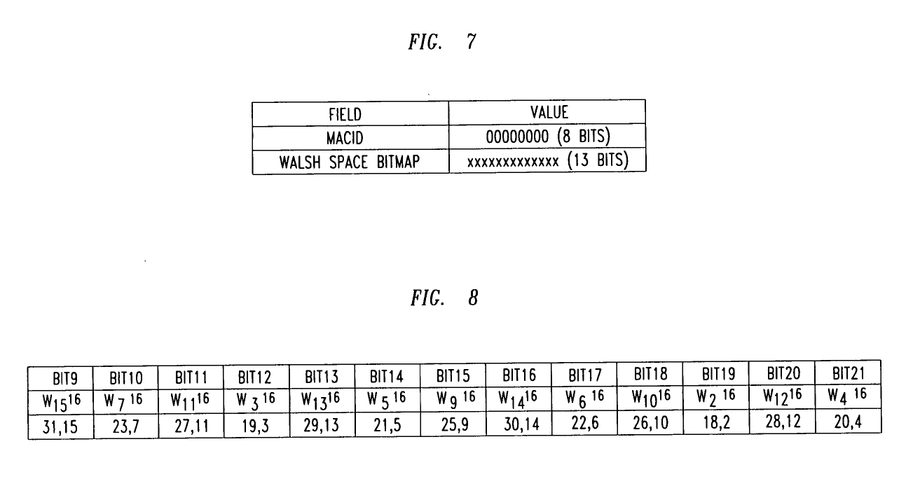

A system simulation results demonstrate that such a broadcast mechanism can be made reliable, even for users at low Geometries that are in long/deep fades. This may be achieved by retransmission of the Walsh space broadcast at a time interval that ensures that the probability of any user missing both transmissions is low. This may be derived from long-term link level curves, is that even a 4-slot transmission cannot reach such a user reliably when voice loading is at 80%. Each of the 13 bits in the Walsh Space Bitmap field may indicate the availability (or unavailability) of a specific 16-ary Walsh code, thereby the availability (or unavailability) of the two 32-ary Walsh codes derived from it, as shown in FIG. 8.

In should be noted that the case that the Walsh space broadcast is made periodically, the metric that should be used is the probability that successive Walsh broadcasts may be missed by a user, rather than a single broadcast, when the available space is changing slowly due to voice activity. For fast changing Walsh Space, two 2-slot transmissions spaced 40 ms apart (the actual time spacing is a function of the user speeds in the system), may achieve a much higher reliability than a single transmission over 4 slots, while not requiring any more energy.

Walsh Space Broadcast via the F-SPDCCH may be made sufficiently reliable (comparable to the overall reliability of the F-SPDCCH for any scheduled user) for all users, by repeating the transmission with a time-offset. As an illustration, the worst-case error probability may be around 6% for a single 4-slot long F-SPDCCH transmission. However making 2 2-slot transmissions separated by 40 ms, may reduce this error rate to less than 1.8%. This improvement in performance may be obtained without any additional resource (energy/power/time) utilization. Further, the mechanism of sending the Walsh Space Broadcast periodically every 100 ms may also be shown reliable, as the probability of any user successively erring on two such broadcasts, is under 2.1% when the 2-slot format is used in the transmission and 0.55% when the 4-slot format is used in the transmission.

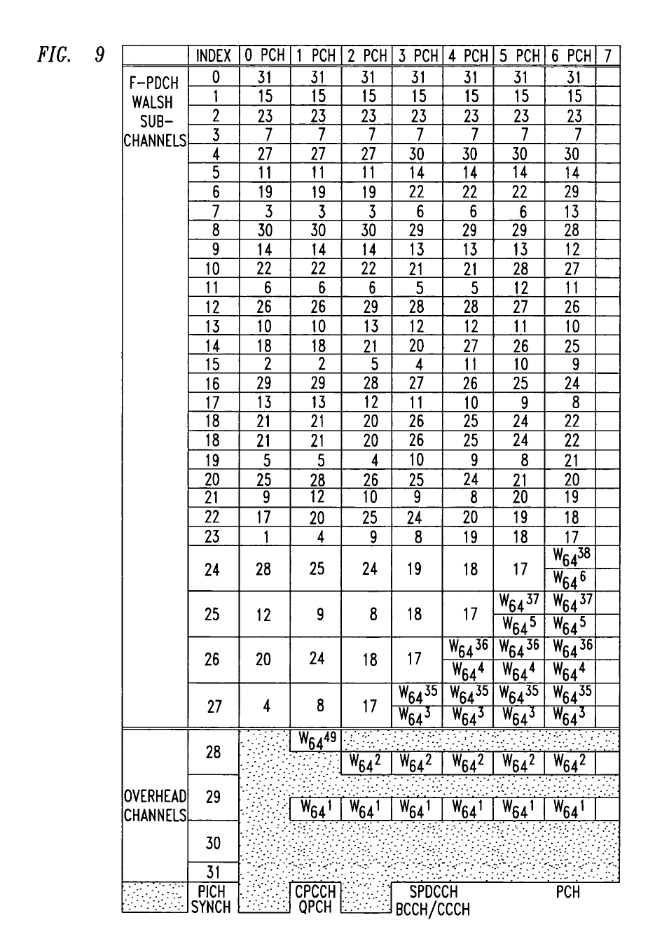

There is no additional delay for assigning the F-SCH, and little delay (one 2-slot broadcast) for recovering the Walsh space used by the F-SCH after the F-SCH may be released. A system simulation demonstrated that such a broadcast mechanism can be made reliable, even for users at low Geometries that are in long/deep fades. This may be achieved by retransmission of the Walsh space broadcast at a time interval that ensures that the probability of any user missing both transmissions may be low. First some voice users may have to be moved from one Walsh code to another. The voice quality may potentially be hurt thusly during this procedure. The FSCH assignment will be delayed, therefore potentially causing delay-related Quality of Service (“QoS”) performance degradation. When the F-SCH is released, the voice users have to be moved back before the Walsh space just released can be used by F-PDCH, causing long delay for recovering the Walsh space and the voice quality degradation. Therefore, the following may be a useful combination for addressing these issues:
1. A 1×EV-DV system uses the 5-bit Last Walsh Code Index on a regular F-SPDCCH to dynamically indicate the Walsh Code Assignment for F-PDCH when the Available Walsh Space for F-PDCH is not fragmented;
2. When the available Walsh space for F-PDCH becomes fragmented or becomes unfragmented, or the fragmentation pattern changes, an alternative interpretation of SPDCCH, may be used to broadcast the fragmentation status the first 13 16-ary Walsh codes using a bitmap. The mobiles may use this Fragmentation Indication as well as the 5-bit Last Walsh Code Index on a regular FSPDCCH to derive the Walsh code Assignment for the F-PDCH. The base station may repeat this broadcast at a specific time, such as 40 ms, later. An alternative can be that the base station repeats this broadcast, if not, all mobiles may ACK the broadcast; and
3. A unique Default Walsh List for each number of Paging Channel may be defined as illustrated in FIG. 9 or FIG. 10, depending on the decision on Walsh spreading on F-SPDCCH.

Referring to FIG. 11, a Walsh Tree and the fixed Walsh code assignments for some IS-95A/B and IS-2000-A Forward channels is shown. In addition, Spreading Rate 1(1×) Forward channels may be expressed as follows:
1. If an Auxiliary Pilot Channel is present, it may be assigned a code channel Wₙ^{N}, where N≦512, and 1≦n ≦N−1. If an Auxiliary Pilot Channel is used with an Auxiliary Transmit Diversity Pilot Channel, then the Auxiliary Pilot Channel may be assigned a code channel Wₙ^{N}, and the Auxiliary Transmit Diversity Pilot Channel may be assigned a code channel W_{n+N/}2N, where N≦512 and 1≦n≦N/2−1. The value of N and n are specified by the base station.
2. If a rate ½ coded Broadcast Control Channel (BCCH) is present, it may be assigned to a code channel Wₙ⁶⁴, where 1≦n≦63. If a rate ¼ coded BCCH is present, it may be assigned to a code channel Wₙ³², where 1≦n≦31. The value of n is specified by the base station.
3. If a Common Power Control Channel (CPCCH) operating in the non-TD mode is present, it may be assigned to a code channel Wₙ¹²⁸, where 1≦n≦127. If a CPCCH operating in the OTD or STS mode is present, it may be assigned to a code channel Wₙ⁶⁴, where 1≦n≦63. The value of n is specified by the base station.
4. If a rate ½ coded Common Assignment Channel (CACH) is present, it may be assigned to a code channel Wₙ¹²⁸, where 1≦n≦127. If a rate ¼ coded CACH is present, it may be assigned to a code channel Wₙ⁶⁴, where 1≦n≦63. The value of n is specified by the base station.
5. If a rate ½ coded Common Control Channel (CCCH) is present, it may be assigned to a code channel Wₙ^{N}, where N=32, 64, and 128 for the data rate of 38400 bps, 19200 bps, and 9600 bps, respectively, and 1≦n≦N−1. If a rate ¼ coded CCCH is present, it may be assigned to a code channel Wₙ^{N}, where N=16, 32, and 64 for the data rate of 38400 bps, 19200 bps, and 9600 bps, respectively, and 1≦n≦N −1. The value of n is specified by the base station.
6. Each Fundamental Channel (FCH) and Supplemental Code Channel with Radio Configuration (RC) 1 or 2 may be assigned to a code channel Wₙ⁶⁴, where 1≦n≦63. The value of n is specified by the base station.
7. Each FCH and Dedicated Control Channel (DCCH) with RC 3 or 5 may be assigned to a code channel Wₙ⁶⁴, where 1≦n≦63. Each FCH and DCCH with RC 4 shall be assigned to a code channel Wₙ¹²⁸, where 1≦n≦127. The value of n is specified by the base station.
8. Each Supplemental Channel (SCH) with RC 3, 4, or 5 may be assigned to a code channel Wₙ^{N}, where N=4, 8, 16, 32, 64, 128, 128, and 128 for the maximum assigned QPSK symbol rate of 307200 sps, 153600 sps, 76800 sps, 38400 sps, 19200 sps, 9600 sps, 4800 sps, and 2400 sps, respectively, and 1≦n≦N−1. The value of n is specified by the base station.

While the particular invention has been described with reference to illustrative embodiments, this description is not meant to be construed in a limiting sense. It is understood that although the present invention has been described, various modifications of the illustrative embodiments, as well as additional embodiments of the invention, will be apparent to one of ordinary skill in the art upon reference to this description without departing from the spirit of the invention, as recited in the claims appended hereto.

Consequently, the method, system and portions thereof and of the described method and system may be implemented in different locations, such as the wireless unit, the base station, a base station controller and/or mobile switching center. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. Those skilled in the art will readily recognize that these and various other modifications, arrangements and methods can be made to the present invention without strictly following the exemplary applications illustrated and described herein and without departing from the spirit and scope of the present invention It is therefore contemplated that the appended claims will cover any such modifications or embodiments as fall within the true scope of the invention.

1. A method of wireless communication comprising:
receiving a Walsh code-based signal; and
determining at least one unassigned Walsh code in response to Walsh code-based signal.

2. The method of claim 1, wherein the Walsh code-based signal comprises an information field having a number of bits.

3. The method of claim 2, wherein each bit of the information field corresponds with at least one of a number of indices in a look-up table within a wireless unit.

4. The method of claim 3, wherein the indices correspond with at least one unassigned Walsh code.

5. The method of claim 4, wherein the step of determining at least one unassigned Walsh code comprises:
mapping one bit from the Walsh code-based signal to at least one of the indices in the look-up table; and
removing at least one of the indices in response to a value of the corresponding one bit.

6. The method of claim 5, wherein each bit from the Walsh code-based signal corresponds with at least two indices in the look-up table.

7. The method of claim 6, wherein the step of determining at least one unassigned Walsh code comprises:
receiving a Walsh Table ID signal; and
identifying unassigned Walsh codes in response to the remaining indices and the Walsh Table ID signal.

8. The method of claim 7, wherein the Walsh Table ID signal corresponds with a column on the look-up table.

9. The method of claim 7, wherein the Walsh Table ID signal corresponds with a maximum number of paging channels used by a base station.

10. The method of claim 7, further comprising:
placing a call using at least one of the identified unassigned Walsh codes over at least one packet data channel.

11. The method of claim 10, wherein the step of placing a call comprises:
examining a Last Walsh Code Index for each of the identified unassigned Walsh codes if at least two packet data channels are available;
categorizing the identified unassigned Walsh codes with one packet data channel if a corresponding look-up index is in a first range; and
categorizing the identified unassigned Walsh codes with another packet data channel if a corresponding look-up index is in a second range.

12. The method of claim 11, wherein the first range is between zero and a first integer number, N. and the second range is between N+1 and a second integer number, M.

13. The method of claim 12, wherein the second integer number, M, is a variable number.

14. The method of claim 12, wherein the second integer number, M, corresponds with available resources.

15. A method of wireless communication comprising:
examining a number of channels in use;
configuring a Walsh Table ID signal to be greater than the number of channels; and
transmitting the Walsh Table ID signal.

16. The method of claim 15, wherein at least two of the channels are paging channels.

17. The method of claim 15, wherein the Walsh Table ID signal corresponds with a column on a look-up table.

18. The method of claim 15, wherein the Walsh Table ID signal corresponds with a maximum number of paging channels used by a base station.

19. The method of claim 18, wherein a carrier frequency for the paging channels used by a base station is the same as the carrier frequency for a shared data channel.

20. A method of wireless communication comprising:
examining a Last Walsh Code Index for each identified unassigned Walsh code if at least two data channels are available;
categorizing the identified unassigned Walsh codes with one data channel if a corresponding look-up index is in a first range; and
categorizing the identified unassigned Walsh codes with another packet data channel if a corresponding look-up index is in a second range.

21. The method of claim 20, further comprising:
placing a data call using at least one identified unassigned Walsh code over at least one data channel.

22. The method of claim 20, wherein the first range is between zero and a first integer number, N, and the second range is between N+1 and a second integer number, M.

23. The method of claim 22, wherein the second integer number, M, is a variable number corresponding with available resources.
